(19) United States
(12) Patent Application Publication
(10) Pub. No.: US 2014/0201792 A1
(43) Pub. Date: Jul. 17, 2014

(54) METHOD AND APPARATUS FOR PROVIDING CHANNEL-ASSOCIATED OPTIONAL SERVICE

(71) Applicants: KT Corporation, Seongnam-si (KR); Electronics and Telecommunications Research Institute, Daejeon (KR)

(72) Inventors: Eun-Jun RHEE, Daejeon-si (KR); Hyun-Woo LEE, Daejeon-si (KR); Won RYU, Daejeon-si (KR); Dae-Gun KIM, Seongnam-si (KR)

(73) Assignees: KT Corporation, Seongnam-si (KR); Electronics and Telecommunications Research Institute, Daejeon (KR)

(21) Appl. No.: 14/154,663

(22) Filed: Jan. 14, 2014

(30) Foreign Application Priority Data
Jan. 14, 2013 (KR) 10-2013-0004078

(51) Int. Cl. H04N 21/278; H04N 21/235; H04N 21/4722; H04N 21/232

(52) U.S. Cl. CPC H04N 21/278; H04N 21/232; H04N 21/235; H04N 21/4722
USPC 725/43; 725/116; 725/115

(57) ABSTRACT

A method and apparatus for providing a channel-associated optional service. The method for providing a channel-associated optional service includes transmitting, in response to a service request from a user terminal, the service request to a broadcast receiving device that is mapped with the user terminal using an identifier mapping table; receiving channel information of a currently received program from the broadcast receiving device that has received the service request, and searching for program information of a relevant channel using the received channel information; searching for optional service information related to a program scheduled to be currently broadcast using the found program information; and providing the found optional service information to the user terminal.

### CROSS-REFERENCE TO RELATED APPLICATION(S)

This application claims priority from Korean Patent Application No. 10-2013-0004078, filed on Jan. 14, 2013, in the Korean Intellectual Property Office, the disclosure of which is incorporated herein by reference in its entirety.

### BACKGROUND

1. Field

The following description relates to the provision of optional information of broadcast content, and more particularly, to the provision of optional information related to a program output through a television.

2. Description of the Related Art

IPTV, which is in wide use today allows for a two-way communication between a user and a broadcast. IPTV offers optional services, such as, weather, stock information, and game services, using a two-way communication function, but such optional services have limitations in terms of providing services related to a channel program currently viewed by a user.

For example, even when an optional service related to an intended channel program is available, an IPTV television display screen needs to be divided into sections to display the optional service-relevant information on one of the sections, or the information may be displayed as overlapping images on the screen. Hence, such display of the optional service may lower the level of user's concentration on the program or disturb the user from watching the program.

### SUMMARY

The following description relates to a method and apparatus for providing an optional service related to an intended channel program, at the same time, increasing the level of user's concentration on the channel program.

In one general aspect, there is provided a method for providing a channel-associated optional service by a channel synchronizing device, the method including: transmitting, in response to a service request from a user terminal, the service request to a broadcast receiving device that is mapped with the user terminal using an identifier mapping table; receiving channel information of a currently received program from the broadcast receiving device that has received the service request, and searching for program information of a relevant channel using the received channel information; searching for optional service information related to a program scheduled to be currently broadcast using the found program information; and providing the found optional service information to the user terminal.

The transmitting of the service request may include receiving a service request message containing a terminal identifier from the user terminal; searching an identifier mapping table for an identifier and IP address of a broadcast receiving device, which are mapped with the received terminal identifier; and transmitting the service request message to the broadcast receiving device using the found IP address of a broadcast receiving device.

The searching for the program information of the relevant channel may include receiving channel information, containing a channel identifier of the currently received program, from the broadcast receiving device; and searching for program guide information of a channel corresponding to the channel identifier received from the broadcast receiving device, and then searching for an identifier of a program scheduled to be currently broadcast.

The searching for the identifier of the program scheduled to be currently broadcast may include periodically receiving channel information and channel program guide information from a headend, and storing the received information in a database; and searching for program guide information of a current channel from the database.

The searching for the optional service information may include: periodically receiving program-related optional service information from a program provider or an Internet content provider, and storing the information in a database; and searching for the optional service information related to the program scheduled to be currently broadcast from the database.

The searching for the optional service information may include requesting a program provider or an Internet content provider, and receiving the optional service information related to the program scheduled to be currently broadcast.

The method may further include: in response to receiving a new service request from the user terminal, searching the identifier mapping table for a broadcast receiving device identifier that is mapped with a terminal identifier, transmitting the service request message to a corresponding broadcast receiving device using the found broadcast receiving device identifier; and providing, in response to receiving identifier information of a currently received channel, from the broadcast receiving device, the user terminal with an optional service related to a program scheduled to be currently broadcast on the channel.

The method may further include storing, in advance, a mapping table that contains a terminal identifier, and an identifier and IP address of a broadcast receiving device in a database, so as to enable the channel synchronizing device to search the identifier mapping table.

The method may further include, in response to change of the IP address of the broadcast receiving device to a new IP address, receiving from the broadcast receiving device the identifier, the previous IP address and the new IP address of the broadcast receiving device, mapping the received information to the mapping table, and storing the mapping table in the database.

In another general aspect, there is provided a channel synchronizing device including: a controller configured to search for, in response to a request from a user terminal, a broadcast receiving device that is mapped with a user terminal in an identifier mapping table in a database, to search for program information of a channel corresponding to channel information received from the found broadcast receiving device, and to search for optional service information, related to a program scheduled to be currently broadcast, using the found program information; and a communicator configured to receive a service request from the user terminal, to receive channel information of a currently received program from the broadcast receiving device that is mapped with the user terminal, and to provide the user terminal with the optional service information found by the controller.

The communicator may be configured to receive channel information containing a channel identifier of the currently received program from the broadcast receiving device, and the controller is configured to search for program guide information of a channel corresponding to the channel identifier received through the communicator and, then, search for an identifier of the program scheduled to be currently broadcast.

The communicator may be configured to periodically receive channel information and channel program guide information from a headend, and the controller may be configured to store and manage the received channel information and channel program guide information in the database, and to search for program guide information of a current channel from the database.

The communicator is configured to periodically receive program-related optional service information from a program provider or an Internet content provider, and the controller is configured to store and manage the received optional service information in the database, and to search for optional service information related to the program scheduled to be currently broadcast from the database.

The controller may be configured to store, in advance, and manage a mapping table that contains a terminal identifier, and an identifier and IP address of a broadcast receiving device in a database for the identifier mapping table search.

The communicator may be configured to, in response to change of an IP address of the broadcast receiving device to a new one, receive from the broadcast receiving device the identifier, the previous IP address and the new IP address of the broadcast receiving device, map the received information to the mapping table, and store and manage the mapping table in the database.

Other features and aspects will be apparent from the following detailed description, the drawings, and the claims.

### BRIEF DESCRIPTION OF THE DRAWINGS

FIG. 1 is a diagram illustrating an apparatus for providing a channel-associated optional service.

FIG. 2 is a diagram illustrating in detail the channel synchronizing device of FIG. 1.

FIG. 3 is a flowchart illustrating an identifier mapping table management process of a channel synchronization device according to an exemplary embodiment of the present invention.

FIG. 4 is a flowchart illustrating channel-associated optional service provision process according to an exemplary embodiment of the present invention.

FIG. 5 is a diagram illustrating a screen of a user terminal on which a channel-associated optional service is displayed in association with a broadcast receiving device, according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

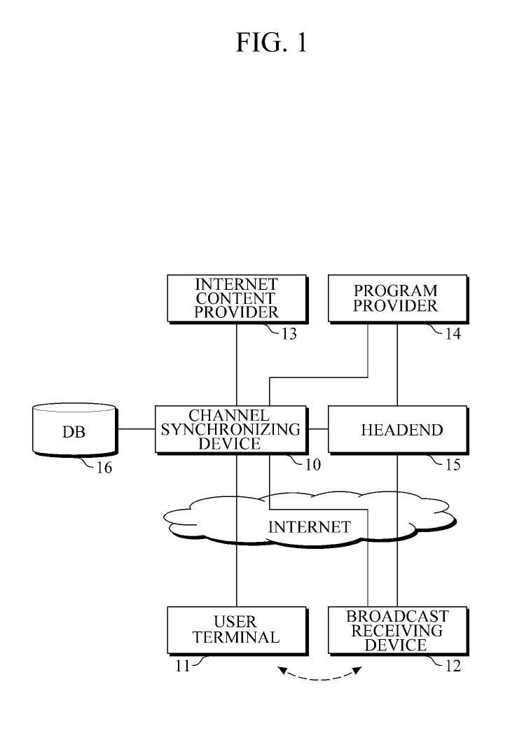

FIG. 1 is a diagram illustrating an apparatus for providing a channel-associated optional service.

Referring to FIG. 1, an optional service information providing system may include a channel synchronizing device 10, a user terminal 11, a broadcast receiving device 12, an Internet content provider 13, a program provider 14, a headend 15, and a database 16.

The channel synchronizing device 10 provides the user terminal 11 with optional service information related to a program on a broadcast channel that is currently received by the broadcast receiving device 12. In specific, the optional service information related to channel programs is not displayed on a television screen via the broadcast receiving device 12, but is transmitted to the user terminal 11, and displayed on a user terminal's screen.

This is to avoid the interruption or distraction to a viewer, which may be caused by the divided or overlaying images on the screen when the optional service information is displayed on the TV screen via the broadcast receiving device 12. Here, the optional service information is data containing information about a broadcast program, for example, description of the broadcast program, information about a product used in the program, or a shooting location, a webpage address related to the broadcast program, and the like.

The broadcast receiving device 12 may include a set top box (STB), which may be embedded in the television or provided externally. There may be a number of STBs corresponding to the number of broadcast channels through which broadcast programs are transmitted.

The user terminal 11 is a device to receive about channel-associated optional service information from the channel synchronizing device 10 and display the information on a screen. The user terminal 11 may be a smartphone, a mobile phone, a tablet computer, a personal digital assistant, a personal computer, and the like. The user terminal 11 runs an application to request and receive the channel synchronizing device 10 for the channel-associated optional service information.

The channel synchronizing device 10 may obtain the channel-associated optional service information from the program provider 14 or the Internet content provider 13. The program provider 14 provides the broadcast program to the broadcast receiving device 12 through the headend 15.

The database 16 stores a mapping table containing terminal identifiers, broadcast receiving device identifiers, and IP addresses. In addition, the database 16 stores program guide information of each channel and optional service information related to each program. The terminal identifier may be, for example, a phone number of the user terminal 11, or, if a phone number is not available, be a Wi-Fi MAC address or a unique serial number.

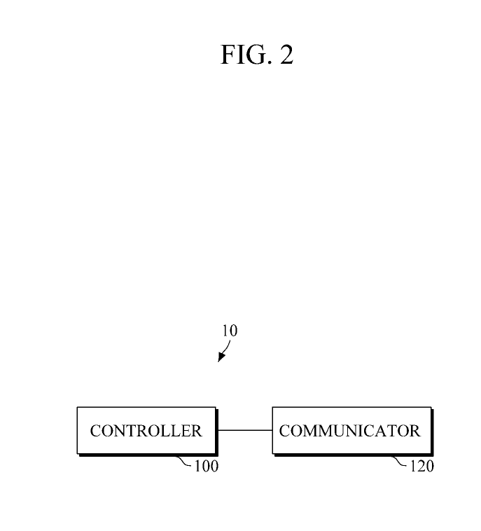

FIG. 2 is a diagram illustrating in detail the channel synchronizing device of FIG. 1.

Referring to FIGS. 1 and 2, the channel synchronizing device 10 includes a controller 100 and a communicator 120.

In response to a service request from the user terminal 11, the controller 100 may search for the broadcast receiving device 12 mapped to the user terminal 11, using an identifier mapping table stored in the database 16, and search program information of an intended channel by using channel information received from the found broadcast receiving device 12 through the communicator 120.

The communicator 120 receives a service request from the user terminal 11, receives channel information of a currently broadcast program from the broadcast receiving device 12 that is mapped to the user terminal 11, and provides the user terminal 11 with the optional service information found by the controller 100.

In one example, the communicator 120 receives channel information containing a channel identifier related to the currently broadcast program from the broadcast receiving device 12. The controller 100 uses the channel identifier received through the communicator 120 to search for program guide information of a corresponding channel, and to further search for an identifier of a program scheduled to be currently broadcast.

In this case, the communicator 120 may periodically receive channel information and channel program guide information from the headend 15. Then, the controller 100 may store and manage the channel information and the channel program guide information, which are received through the communicator 120, in the database 16, and search for the program guide information of the current channel from the channel program guide information stored in the database 16.

In one example, the communicator 120 may periodically receive program-related optional information from the program provider 14 or the Internet content provider 13. Then, the controller 100 stores and manages the optional service information received through the communicator 120 in the database 16, and searches for optional service information related to the current program from the optional service information stored in the database 16.

In one example, to search the identifier mapping table, the controller 100 stores, in advance, a mapping table containing terminal identifiers, broadcast receiving device identifier, and IP addresses in the database 16 for management.

In an event where an IP address of the broadcast receiving device 12 is changed, the communicator 120 receives a broadcast receiving device identifier, an IP address of a previous broadcast receiving device, and an IP address of a new broadcast receiving device from the broadcast receiving device 12. Then, the controller 100 maps the information received through the communicator 120 to the mapping table, and stores and manages the mapping table in the database 16.

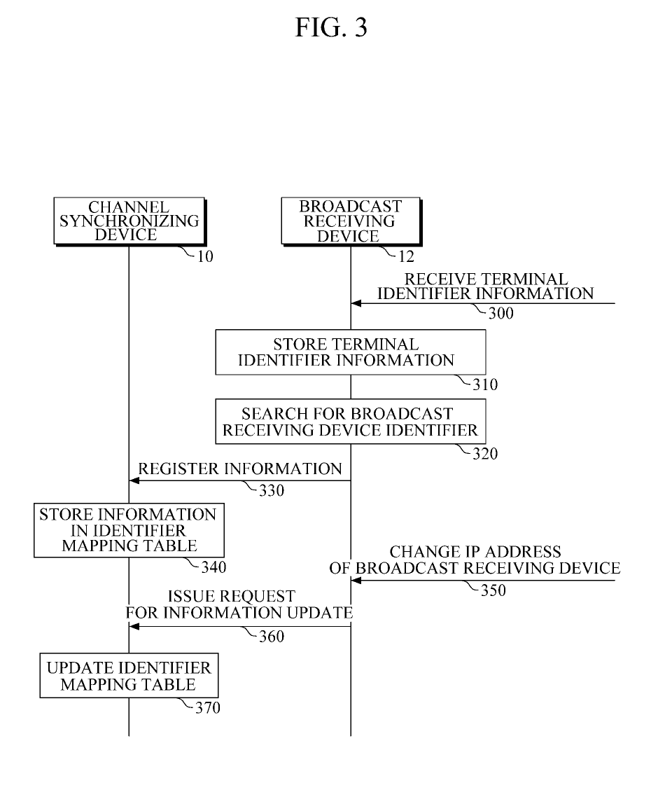

FIG. 3 is a flowchart illustrating an identifier mapping table management process of a channel synchronization device according to an exemplary embodiment of the present invention.

Referring to FIG. 3, a broadcast receiving device 12 and a corresponding user terminal 11 are required to be registered and managed, such that the user terminal 11, in association with the broadcast receiving device 12, can be provided with optional services from a channel synchronizing device 10, and thereby can display the optional service on a screen.

First, the broadcast receiving device 12 receives terminal identifier from the user terminal 11 in 300. A user may transmit the terminal identifier by inputting a user instruction to the user terminal 11. The terminal identifier may be, for example, a call number of the user terminal 11, or, if the call number is not available, be a Wi-Fi MAC address, other unique serial number, or the like.

In response to receiving the terminal identifier, in 310, the broadcast receiving device 12 stores the received identifier, and searches for its own identifier and IP address in 320. Then, in 330, the broadcast receiving device 12 transmits the received terminal identifier, its own identifier, and IP address to a channel synchronizing device 10 for registration. This process may be performed through a channel associated service agent mounted in the broadcast receiving device 12.

The channel synchronizing device 10 maps the terminal's identifier, and the identifier and IP address of the broadcast receiving device to a mapping table, and stores the mapping table for management in 340.

In a case where its own IP address has changed in 350, the broadcast receiving device 12 transmits a message to the channel synchronizing device 10 to request an update of identifier mapping table. The message to be transmitted to the channel synchronizing device 10 may include the identifier, the previous IP address, and the new IP address of the broadcast receiving device 12. Then, the channel synchronizing device 10 may update the identifier mapping table in response to the received information update request in 370. Accordingly, the channel synchronizing device 10 can maintain the up-to-date identifier mapping table.

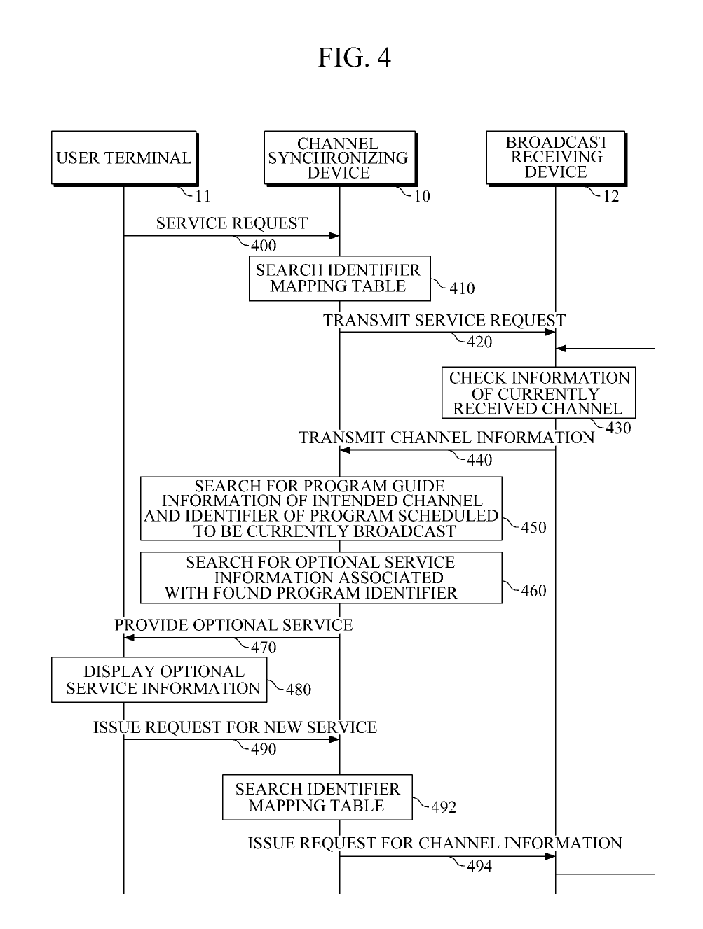

FIG. 4 is a flowchart illustrating channel-associated optional service provision process according to an exemplary embodiment of the present invention.

Referring to FIGS. 1 and 4, the user terminal 11 transmits a channel-associated optional service request message, along with its own identifier, to the channel synchronizing device 10 in 400. At this time, the user terminal 11 may include its own identifier in a message (hereinafter referred to as an “app start message”) that indicates that the user terminal 11 itself is activated, and transmits the app start message to the channel synchronizing device 10 through an application (hereinafter referred to as a “channel-associated service app”) that enables the user terminal 11 to receive a channel-associated service. An example herein described assumes that the user terminal 11 transmits the app start message to the channel synchronizing device 10 by running an application, but the aspects of the invention are not limited thereto.

In response to the app start message transmitted from the user terminal 11, the channel synchronizing device 10 searches the identifier mapping tale for an identifier and IP address of a broadcast receiving device, which correspond to the terminal's identifier in 410, wherein the identifier mapping table is stored and managed in the database 16, and transmits an app start notification message to the broadcast receiving device 12 using the found IP address of a broadcast receiving device 12 in 420. The app start notification message includes the identifier of the user terminal 11.

In response to receiving the app start notification message, a channel-associated service agent of the broadcast receiving device 12 checks information about a currently received channel in 430, and transmits to the channel synchronizing device 10 a channel information notification message that includes a channel identifier of the current channel in 440.

In 450, in response to receiving the channel information notification message including the channel identifier, the channel synchronizing device 10 searches for program guide information of a channel corresponding to the channel identifier, and then searches for a program identifier of a program scheduled to be currently broadcast. In one example, the channel synchronizing device 10 periodically receives channel information and the relevant program guide information from the headend 15, and stores the received information in the database 16, and searches the database 16 for the program guide information of the current channel using the channel identifier.

Then, the channel synchronizing device 10 searches for optional service information associated with the found program identifier in 460. In one example, the channel synchronizing device 10 may periodically receive the optional service information from the program provider 14 or the Internet content provider 13, store and manage the information in the database 16, and search the database 16 for the optional service information related to the program on the current channel. In addition, upon request from the channel synchronizing device 10, optional service information may be transmitted from the program provider 14 or the Internet content provider 13.

In an event where optional service information associated with the intended program is found, the channel synchronizing device 10 transmits the terminal identifier, the channel and program information (channel number, program title, etc.), and optional service information associated with the intended channel and program to the user terminal 11 in 470. In response to receiving the optional service information associated with the intended channel and program, the user terminal 11 enables a user to use the information by displaying it on a display in 480.

Meanwhile, the user terminal 11 may request the channel synchronizing device 10 for new channel-associated optional service information in 490 by sending a channel-associated optional service information request message through a channel-associated service application.

In response to the channel-associated optional service information request message, the channel synchronizing device 10 searches the identifier mapping table in 492 to confirm the IP address of the corresponding broadcast receiving device 12, and transmits a channel information request message, including the terminal identifier, to the broadcast receiving device 12 based on the confirmed IP address in 494.

Thereafter, the broadcast receiving device 12 checks the currently receiving channel information, and transmits a channel information notification message, including the channel identifier, to the channel synchronizing device 10, and in response to the message, the channel synchronizing device 10 transmits to the user terminal 11 optional services related to a program with respect to new channel information.

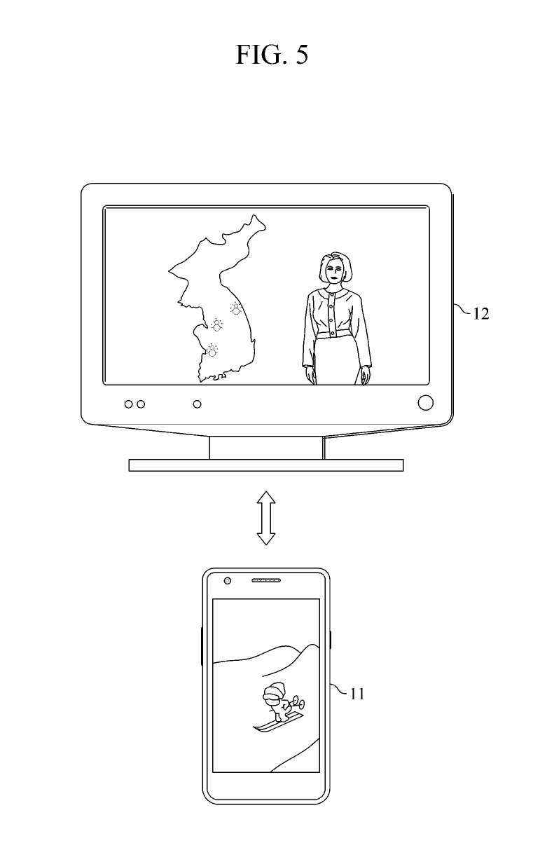

FIG. 5 is a diagram illustrating a screen of a user terminal on which a channel-associated optional service is displayed in association with a broadcast receiving device, according to an exemplary embodiment of the present invention.

Referring to FIG. 5, it is assumed that a user is watching a weather forecast program on a particular channel through a broadcast receiving device 12. In a case where a user terminal 11 requests a channel synchronizing device 10 for a channel-associated optional service, the channel synchronizing device 10 provides the user terminal 11 with optional service information related to the program on the channel currently received through a broadcast receiving device 12. Then, the user terminal 11 displays the optional service information on the screen. For example, as shown in FIG. 5, the user terminal 11 may display information about ski resorts on the screen, in relation to the weather information, snow, provided by the current program.

As described above, according to the exemplary embodiments of the present invention, a user who is watching a particular channel of an IPTV is enabled to use information related to the currently viewed IPTV channel information through user's own terminals, such as, smart devices. Accordingly, the user can easily use optional services associated with the currently viewed program, without disruptions to the TV program image on the screen.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for providing a channel-associated optional service by a channel synchronizing device, the method comprising:
transmitting, in response to a service request from a user terminal, the service request to a broadcast receiving device that is mapped with the user terminal using an identifier mapping table;
receiving channel information of a currently received program from the broadcast receiving device that has received the service request, and searching for program information of a relevant channel using the received channel information;
searching for optional service information related to a program scheduled to be currently broadcast using the found program information; and
providing the found optional service information to the user terminal.

2. The method of claim 1, wherein the transmitting of the service request comprises receiving a service request message containing a terminal identifier from the user terminal; searching an identifier mapping table for an identifier and IP address of a broadcast receiving device, which are mapped with the received terminal identifier; and transmitting the service request message to the broadcast receiving device using the found IP address of a broadcast receiving device.

3. The method of claim 1, wherein the searching for the program information of the relevant channel comprises receiving channel information, containing a channel identifier of the currently received program, from the broadcast receiving device; and searching for program guide information of a channel corresponding to the channel identifier received from the broadcast receiving device, and then searching for an identifier of a program scheduled to be currently broadcast.

4. The method of claim 3, wherein the searching for the identifier of the program scheduled to be currently broadcast comprises periodically receiving channel information and channel program guide information from a headend, and storing the received information in a database; and searching for program guide information of a current channel from the database.

5. The method of claim 1, wherein the searching for the optional service information comprises: periodically receiving program-related optional service information from a program provider or an Internet content provider, and storing the information in a database; and searching for the optional service information related to the program scheduled to be currently broadcast from the database.

6. The method of claim 1, wherein the searching for the optional service information comprises requesting a program provider or an Internet content provider, and receiving the optional service information related to the program scheduled to be currently broadcast.

7. The method of claim 1, further comprising:
in response to receiving a new service request from the user terminal, searching the identifier mapping table for a broadcast receiving device identifier that is mapped with a terminal identifier, transmitting the service request message to a corresponding broadcast receiving device using the found broadcast receiving device identifier; and providing, in response to receiving identifier information of a currently received channel, from the broadcast receiving device, the user terminal with an optional service related to a program scheduled to be currently broadcast on the channel.

8. The method of claim 1, further comprising:
storing, in advance, a mapping table that contains a terminal identifier, and an identifier and IP address of a broadcast receiving device in a database, so as to enable the channel synchronizing device to search the identifier mapping table.

9. The method of claim 8, further comprising:
in response to change of the IP address of the broadcast receiving device to a new IP address, receiving from the broadcast receiving device the identifier, the previous IP address and the new IP address of the broadcast receiving device, mapping the received information to the mapping table, and storing the mapping table in the database.

10. A channel synchronizing device comprising:
a controller configured to search for, in response to a request from a user terminal, a broadcast receiving device that is mapped with a user terminal in an identifier mapping table in a database, to search for program information of a channel corresponding to channel information received from the found broadcast receiving device, and to search for optional service information, related to a program scheduled to be currently broadcast, using the found program information; and
a communicator configured to receive a service request from the user terminal, to receive channel information of a currently received program from the broadcast receiving device that is mapped with the user terminal, and to provide the user terminal with the optional service information found by the controller.

11. The channel synchronizing device of claim 10, wherein the communicator is configured to receive channel information containing a channel identifier of the currently received program from the broadcast receiving device, and the controller is configured to search for program guide information of a channel corresponding to the channel identifier received through the communicator and, then, search for an identifier of the program scheduled to be currently broadcast.

12. The channel synchronizing device of claim 11, wherein the communicator is configured to periodically receive channel information and channel program guide information from a headend, and the controller is configured to store and manage the received channel information and channel program guide information in the database, and to search for program guide information of a current channel from the database.

13. The channel synchronizing device of claim 10, wherein the communicator is configured to periodically receive program-related optional service information from a program provider or an Internet content provider, and the controller is configured to store and manage the received optional service information in the database, and to search for optional service information related to the program scheduled to be currently broadcast from the database.

14. The channel synchronizing device of claim 10, wherein the controller is configured to store, in advance, and manage a mapping table that contains a terminal identifier, and an identifier and IP address of a broadcast receiving device in a database for the identifier mapping table search.

15. The channel synchronizing device of claim 14, wherein the communicator is configured to, in response to change of an IP address of the broadcast receiving device to a new one, receive from the broadcast receiving device the identifier, the previous IP address and the new IP address of the broadcast receiving device, map the received information to the mapping table, and store and manage the mapping table in the database.
